(19) United States
(12) Patent Application Publication
(10) Pub. No.: US 2008/0154886 A1
(43) Pub. Date: Jun. 26, 2008

(54) SYSTEM AND METHOD FOR SUMMARIZING SEARCH RESULTS

(75) Inventors: Raf Podowski, Pleasant Hill, CA (US); Kasian Franks, Kensington, CA (US)

Correspondence Address: KNOBBE MARTENS OLSON & BEAR LLP, 2040 MAIN STREET, FOURTEENTH FLOOR, IRVINE, CA, 92614, US

(73) Assignee: SeeqPod, Inc., Emeryville, CA (US)

(21) Appl. No.: 11/927,346

(22) Filed: Oct. 29, 2007

Related U.S. Application Data
(60) Provisional application No. 60/855,208, filed on Oct. 30, 2006.

(51) Int. Cl. G06F 17/30

(52) U.S. Cl. 707/5; 707/E17.014

(57) ABSTRACT

A computer-implemented system and process for generating a summary of objects in an electronic database is disclosed. The system provides a set of objects and generates data vectors representing the relationship between terms. The relationship vectors can be used to score sections of an object to determine the most relevant portions, or to provide high-value tags. The tags may additionally be used as suggested queries in a search engine or to retrieve related media objects.

### RELATED APPLICATIONS

This application claims priority to U.S. Provisional Application No. 60/855,208 filed on Oct. 30, 2006, the entirety of which is hereby incorporated by reference.

### BACKGROUND OF THE INVENTION

1. Field of the Invention

The present invention relates to information storage and retrieval systems. More particularly, the present invention relates to a system for generating a summary of an information database or an object within an information database.

2. Description of the Related Art

Phrase based or keyword searching is a common method of searching used for electronic data. Keyword searching searches throughout an information database for instances of the words in the search query. Keyword searching does not, however, give results based on relevance; search query results often include items with no relevance or relationship to one another other than the instance of a word in the search query. For example, a user intending to search products by the technology company Apple may enter the search query “Apple.” The search results, however, would likely include items relating to the apple fruit, songs by the music label Apple, and so on. Consequently, the search query results of phrase based searching often have nothing in common with the user's search intent.

Search methods which relate one object to another object are often used in place of keyword searching in order to provide search query results relevant to the searcher's intent. Such relationship-based search methods vary widely and range from precise to general catch-all approaches. Methods relating text objects can vary widely in precision and approach, quality and quantity. For example, Caid et al., in U.S. Pat. No. 5,619,709, titled “System and Method of Context Vector Generation and Retrieval” relies on context vector generations and dated neural network approaches as opposed to more advanced auto-associative approaches. Weissman et al, in U.S. Pat. No. 6,816,857, uses methods of distance calculation to determine relationships for the purpose of placing meaning-based advertising on websites or to rate document relevance in currently used search engines.

These relationship based searches do not, however simulate the process that a human would use in analyzing relevant information to relate objects with one another. Starting with an object of interest, a researcher typically researches within certain contexts and forms relationships between information gathered during the process of reading and analyzing literature. During this flexible process, the context of interest may change, become refined or shift and take on a new direction depending on the information found or thought processes of the researcher. After the researcher finishes the research process, he is left with a valuable collection of information that is related to a specific theme or context of interest. For example, if the researcher's object of interest was a period of music and the context was the Baroque style, then a researcher might relate compositions to one another, compositions to a composer, compositions to a geographical location or time period. Common relationship-based searches do not simulate this process because they are both inflexible and non-interactive; they neither allow a user to define and control the context and individual relationships during the search, nor do they allow for the quality and quantity of relationships to be determined and visualized interactively by the user.

The results of these searches may not identify relevant portions of retrieved documents or the relevance of an entire database. For example, keyword searching may identify portions of a document in which a term is used in the wrong context. Such systems do not allow a user to quickly find and understand the most relevant portions of a document and the relationship of that document to the user's search. The user may be required to dig through large amounts of materials for an extended period of time to identify these sections. Furthermore, these systems do not identify materials and media related to the user's search that a more flexible human researcher might find given enough time and would consider relevant.

### SUMMARY OF THE INVENTION

Certain embodiments herein provide for a system and computer-implemented method for generating summaries of objects within an electronic database or the database itself. Certain embodiments also provide for an analysis of objects in an electronic database providing suggested queries or related media files.

In one embodiment, a system to generate summaries of objects in an electronic database is provided. First, vectors are constructed for the electronic database. The vectors contain data representing certain relationships between objects in the electronic database. Sections of the electronic database may be scored using the data contained in the relationship vectors. Those sections receiving high scores are utilized to create an object summary.

In another embodiment of the invention, a system for providing suggested queries related to an object is provided. High value terms or sections of the object can be used as tags to provide contextually related searches.

In one embodiment, the system may extract media related to objects in an electronic database. A database or objects in the database are analyzed to score sections and determine high value internal tags. Media objects are analyzed to determine high value external tags. The matching of internal and external tags can be used to reveal one or more media objects related to the objects in the electronic database.

One other embodiment is an electronic system for summarizing information from an electronic search which includes: a memory for receiving a search term from a user; a vector generator configured to generate a plurality of data vectors representing associations between the search term and a plurality of data items in an electronic database, wherein the data items comprise sections; a scoring module configured to calculate a relationship score reflecting the relevance of the data vectors to the sections of the data items; and a summary module configured to determine the most relevant sections of the data items.

Another embodiment is an electronic system for summarizing information from an electronic search. This embodiment includes: means for receiving a search string; means for determining data items relating to the search term, wherein the data items comprise a plurality of sections and the sections comprise a plurality of terms; means for calculating a relationship score reflecting the relevance of the search string to the sections of the data items; and means for providing a summary of the most relevant data items by compiling terms from sections of the relevant data items.

Still another embodiment is a computer-implemented process for generating a summary of data items from an electronic search which includes: receiving a search string; determining data items relating to the search term, wherein the data items comprise a plurality of sections and the sections comprise a plurality of terms; calculating a relationship score reflecting the relevance of the search string to the sections of the data items; and providing a summary of the most relevant data items by compiling terms from sections of the relevant data items.

### BRIEF DESCRIPTION OF THE DRAWINGS

FIG. 1 is a flow chart for one embodiment of a system for generating a relationship network.

FIG. 2 is a flow chart for one embodiment of a system for generating vectors for use with a relationship network based on an electronic information database containing text documents.

FIG. 3A shows a sample document from an information database containing text documents.

FIG. 3B shows the document of FIG. 3A after it has been parsed.

FIG. 4 shows one embodiment of a frame for use with the sample data of FIGS. 3A and 3B.

FIG. 5 shows a sample associative memory module for the term “red” from FIG. 4 at a state where the current term being analyzed in the frame is the core term “red.”

FIG. 6A shows the associative memory module for the term “red” after the system completes its analysis of the information database containing the document of FIG. 3A.

FIG. 6B shows the sample query object vector for the associative memory module of FIG. 6A.

FIG. 7 shows a sample flow chart for a network generation engine.

FIG. 8A shows a sample exclusion filter vector applied to a query object vector

FIG. 8B shows one sample method to generate an expanded query object vector using the filtered query object vector of FIG. 8A.

FIG. 8C shows one sample method to generate expanded associated object vectors using the filtered query object vector of FIG. 8A.

FIG. 8D shows one sample method to use expanded associated object vectors with an expanded query object vector to find associated terms between the associated object vectors and the expanded query object vector in order to produce search results for a query.

FIG. 9 shows a graph visualization for a relationship network created in response to a query for the term “red.”.

FIG. 10 illustrates a relationship network system according to one embodiment.

FIG. 11 is a flow chart for one embodiment of a system for analyzing objects in an electronic database.

FIG. 12 is a flow chart for one embodiment of a system for scoring sections of an object in an electronic database.

FIG. 13 shows one embodiment of a system for analyzing for scoring sections of an object in an electronic database at a state where the first section and first term have been selected.

FIG. 14 shows a sample query object vector.

FIG. 15 is a flow chart for one embodiment of a system for retrieving media related to an object in an electronic database.

### DETAILED DESCRIPTION

In the following description, reference is made to the accompanying drawings which show, by way of illustration, specific embodiments and applications of the invention. Where possible, the same reference numbers are used throughout the drawings to refer to the same or like components. In some instances, numerous specific details are set forth in order to provide a thorough understanding of the present disclosure. The present invention, however, may be practiced without the specific details or with certain alternative equivalent components and methods to those described herein. In other instances, well-known components and methods have not been described in detail so as not to unnecessarily obscure aspects of the present disclosure.

One embodiment of the invention is a computer method and system that creates and discerns relationships between different items in a collection. In one embodiment, a many-to-many relationship is created between data items in a data set. As one example, the data items may be genes, and the data set may be the GENBANK gene database. As will be described in more detail below, embodiments of the system analyze the data items in the data set and thereafter determine and create variable length data vectors, such as query object vectors, that reflect the relationships between the data items in the dataset. The data vectors can then be stored and used as part of data mining tool which analyzes relationships between the data items. For example, one may search for all genes in Genbank that relate to stomach cancer.

In one embodiment of the invention, the data vectors that mark associations between data items are created by first analyzing direct correlations between two data items, and then looking for further, hidden, associations between the data items. In one embodiment, these hidden relationships are determined by iteratively analyzing the distance that each term in the dataset has from other terms. This can be carried out by instructions within personal computer system which provide one means for determining relationships between data items and also between data items and search terms. Thus, for example, the more times that two words are found to be associated with one another in the data set, the closer the relationship between them is formed. In certain embodiments, terms are analyzed by moving a “frame” through each data item. For example, if the data item is a document, the frame may move through the document one line at a time, but covering three lines. As the frame moves down each line of the document, the distance between terms within the frame is analyzed. During this analysis, data vectors are created which store the relationships between each term in the frame. In one embodiment, each term within the entire dataset is represented by one vector. That vector provides the distances and relationships between that term and its related terms.

One embodiment of the invention is a system using the stored data vectors to provide useful information to a user. Such useful information may include summaries of documents, objects, or collections. In these embodiments sections of objects are scored based on the information in the data vectors. The section scores are compared and those sections having the highest scores, representing the most relevant information, may be returned as a summary to a user. For example, the most relevant sentences or paragraphs of a document may be returned as a summary. Alternatively, a document or summary is constructed from relevant sentences or paragraphs from a plurality of other documents. In other embodiments entire documents may be returned that represent individual data that is within a database. Related embodiments may use section scores and individual term scores to determine a group of highly relevant tags. These tags may be used in a keyword search or by a search engine to locate relevant information. In another embodiment, these tags are matched to tags extracted from a media database. The media tags may represent, for example, the most useful information obtained from data surrounding media such as images, video, descriptions, or the like. The most relevant matched tags are used to return the associated media data. For example, a search engine results page may match media data to the objects found by the search.

Another embodiment of the invention is a system and method of using the stored data vectors to provide useful results of a search inquiry. When a person or machine inputs a term as part of a search, the term may be stored to a computer memory, such as Random Access Memory, and the data vector for that term is located. This provides one means for receiving the search string. The terms most relevant to the search term or search string are identified from the data vector. The system then retrieves the data vectors for the most relevant terms in order to expand the search. The terms that are related to the most relevant terms can then be identified, and the process can continue to build a relationship network between the original search term, and all of its related terms. Once the queries are executed and the vectors containing the most relevant terms are scored, a relationship network is built. The resulting network of the submitted term may then be prepared for visualization for further interpretation. In one embodiment, the terms are displayed on a computer screen with a web of links showing how related each search term was to its results. To ensure that the submitted terms stay within a specific context when a relationship network is being built, a thematic context in the form of a filter can be used to control the kind of relationships extracted within the resulting network.

The systems and methods disclosed herein allow a user to interactively engage in information mining, hidden association and connection extraction, relationship network construction and comparison of objects while interactively applying thematic context controls to refine the type of relationships extracted. The systems and methods provide the user with information on how objects within the information database relate to one another, in what contexts they are related, and the strength of their relationship.

By combining an interactive role for the user, similar to what a researcher engages in during the process of experimentation, and applying it to an iterative process of automated text mining methods, certain embodiments discussed herein give the user the ability to choose the direction and define relationships as connections are made between objects of interest in the information searched. Interactively defining and extracting relationships between objects, themes and other contexts provides a valuable level of precision for relationship exploration and discovery in text.

For example, if a user was searching for Baroque compositions in an electronic information database such as the Internet, the user may submit the term “Baroque” to the relationship network system. The user may also choose to direct the search in the direction of Baroque music by using a filter term such as “compositions” in order to avoid results relating to Baroque art. The system would then not only provide information on compositions strongly associated with the term “Baroque,” but also for compositions strongly associated with terms related to “Baroque,” such as composer names “Bach” and “Handel,” compositions involving instruments associated with Baroque music, such as “viola da gamba” or “harpsichord”, or the related art period, “Classical,” and so on.

In one embodiment, the relationship network system disclosed herein may be used for term disambiguation, which provides the ability to distinguish two strings of characters that are exactly the same but that have different meanings dependent upon context such as acronyms that double as identifiers or symbols or actual words. For example, the word “cleave” has two definitions that are opposite of one another.

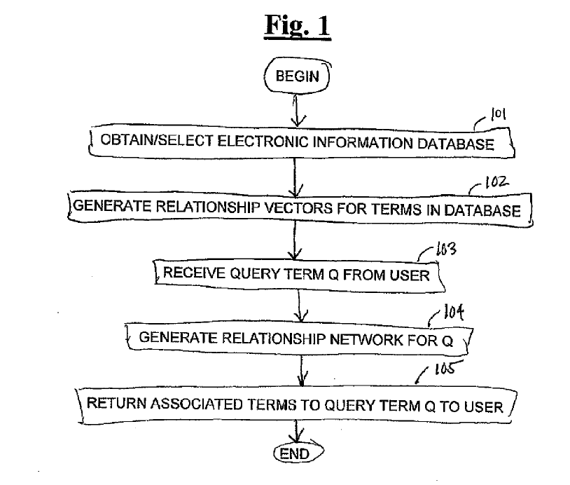

FIG. 1 shows a process 100 for generating a relationship network using an electronic information database. In certain embodiments, an electronic information database may include, but is not limited to, a collection of characters or other forms of text, images, audio, video, or any other data that may be analyzed electronically. Objects or terms within the information database may thus be documents, characters, words, images, songs, or videos (“terms”).

In the embodiment illustrated, the system first selects an electronic information database to process at a state 101. In one example, the database is a database of musical compositions. The system then creates vectors for terms within the database at a state 102. The vectors are created in a way to capture the different strengths of relationships between compositions within the database. Once the vectors are created, the system receives a query “Q” from the user at a state 103. A query is undertaken, for example, when a user would like to find compositions similar to composition listed in the query Q. In certain embodiments, the system may create the vectors before receiving a query in order to reduce data processing expenditures in response to the query. In other embodiments, the vectors may be created after the query is received, Although in certain embodiments a vector is used to store relationships between terms, other data structures may be used in other embodiments. In certain embodiments using vectors, the vector space representation scheme uses variable length query object vectors. The variable length vector may have a plurality of component values or elements that are determined based on relationships between terms. In addition, the variable length vectors may be sized based on the number of associated terms within each vector.

In certain embodiments, associated terms are terms that have either a direct or indirect relationship with each other. In some embodiments, the one term is a “first” term and the second term is a “core term”. In certain embodiments, a direct relationship is where a core term is found within the same frame in a vector as the associated term. In certain embodiments, an indirect relationship is where a core term and the associated term each share a common term in their respective vectors. Other relationships between terms may also be generated for use with certain embodiments discussed herein.

Returning to FIG. 1, in response to a query for term Q from a user at the state 103, the system then generates a relationship network for Q at a state 104 based on the variable length vector(s) for the term Q. In certain embodiments, a relationship network is comprised of a network of relationship vectors whose connections to each other, and the strength of those connections, are based on shared unique attributes within a defined context and theme. Contexts and themes are discussed more specifically below. Once the relationship network has been generated at the state 104, the system may then return terms that are associated with Q at a state 105. For example, the returned terms may point to compositions that are by the same composer as Q, compositions related to Q, or recommendations based on Q.

1. Generating Vectors for a Relationship Network

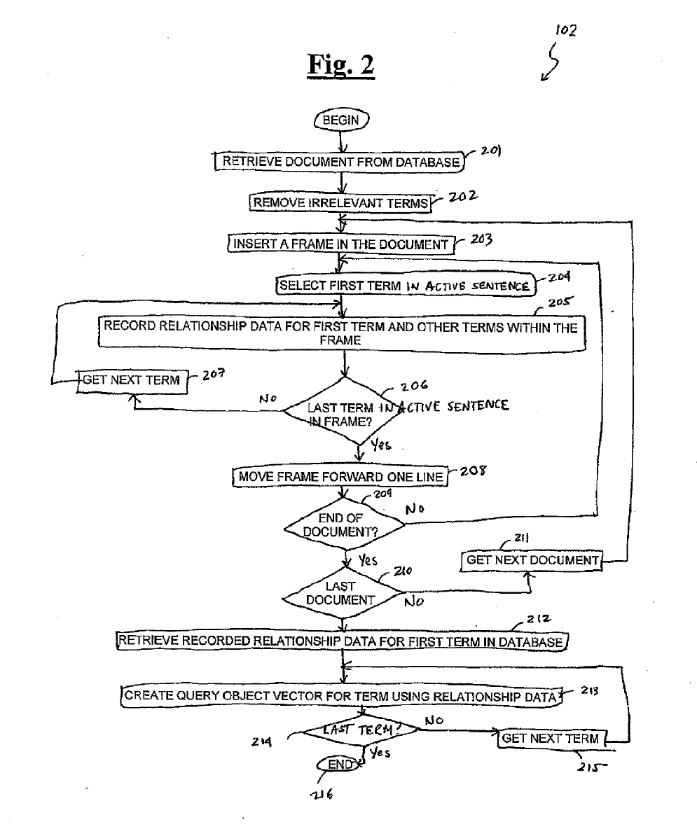

FIG. 2 is a flow chart for one embodiment of the process 102 of generating variable length vectors from data stored within a database. In one embodiment, this process is carried out by a vector generator, which includes instructions for creating the vectors described herein. The process 102 gathers each document in the database at a state 201. For each document that is gathered, the document is parsed at a state 202 in order to remove irrelevant or low value data, such as stop-words (common words such as a, of, as, the, on, etc.). After each document has been parsed at the state 202, the information database contains only valuable terms.

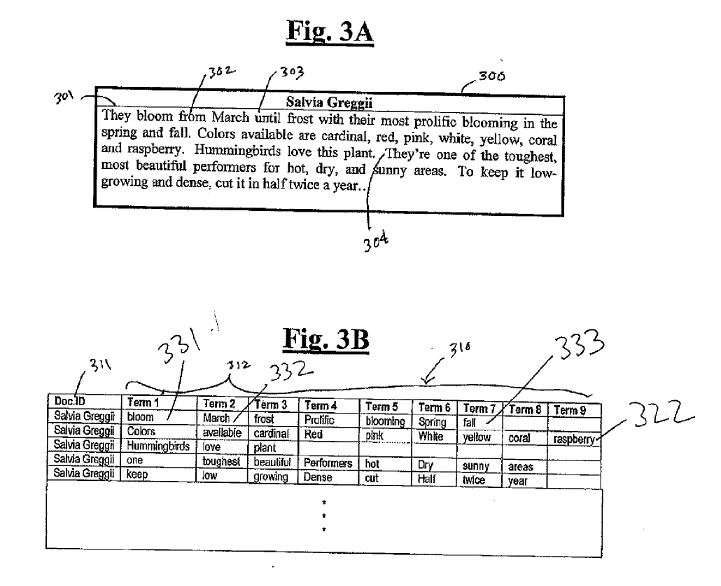

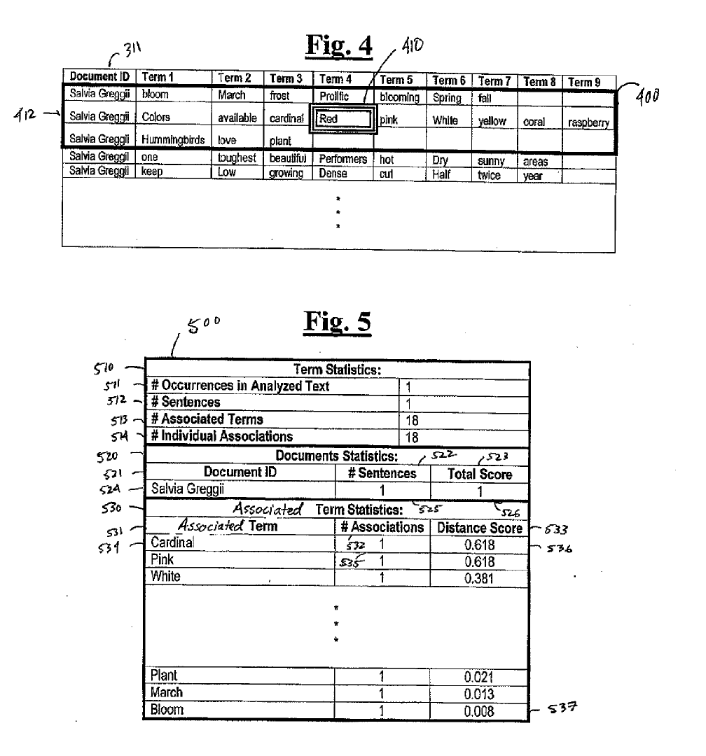

Then, for each parsed document, the system inserts a frame at a state 203 in the document. The frame can be thought of as an overlay that covers one or more lines of text in the documents. For example, the frame may cover three lines or sentences in the document. Once the frame has been inserted at the state 203, the process 102 moves to a state 204 wherein the first term in the first line processed in the frame is selected. FIG. 4 shows one embodiment of a frame 400 for use with the sample data illustrated in FIGS. 3A and 3B. After the first term in the active sentence of the frame is selected at the state 204, a set of relationship data is generated between the first term (“core term”) and the other terms within the frame (“associated terms”) at a state 205. The system records the relationship data for the core term, which includes data such as a calculated distance score for each core term from the first term. In certain embodiments, the relationship data may be stored in an associative memory module, as shown in FIG. 5. Once the relationship data has been generated for the first term, the process 102 moves to a decision state 206 wherein a determination is made whether the last term in the active sentence of the frame is being analyzed. If the current term is not the last term, then the process 102 moves to a state 207 wherein the next term within the frame is captured. The process 102 then returns to the state 205 to calculate the relationship data between the newly captured term and the other core terms within the frame at the state 205. If the term being processed is the last term in the active sentence of the frame, then the process 102 moves to a state 208 wherein the frame is moved ahead by one sentence or line in the document under analysis. If the term is not the last term in the active sentence for the frame, the process 102 moves back to state 205.

Once the process 102 has moved the frame ahead by another line or sentence, a determination is made whether or not the frame is at the end of the document at a decision state 209. If a determination is made that the process 102 is not at the end of the document, then the process 102 returns to the state 204 wherein the first term within the active sentence of the moved frame is selected. If a determination is made that the frame is at the end of the document, then the process 102 moves to a decision state 210 where a determination is made whether or not the process is at the last document in the database. If the process 102 is not at the last document in the database, then the process 102 moves to a state 211 wherein the next document within the database is selected. The process 102 then returns to the state 203 wherein a frame is inserted into the newly gathered document.

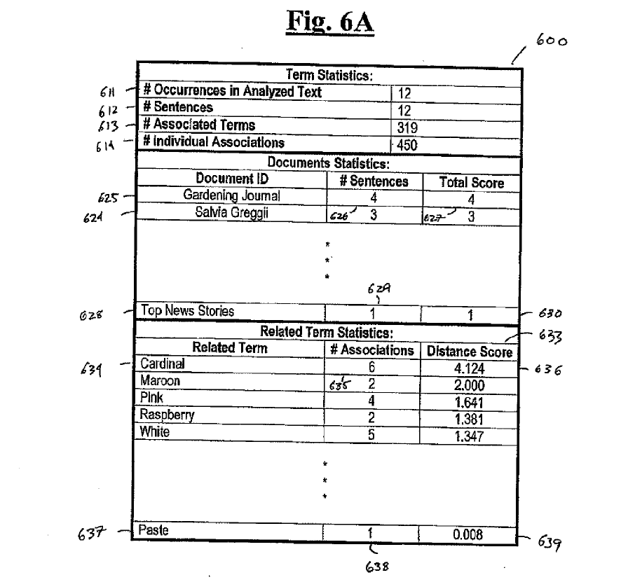

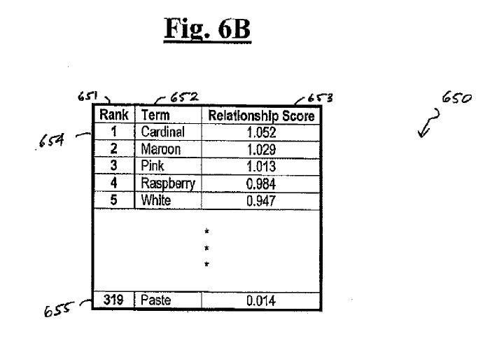

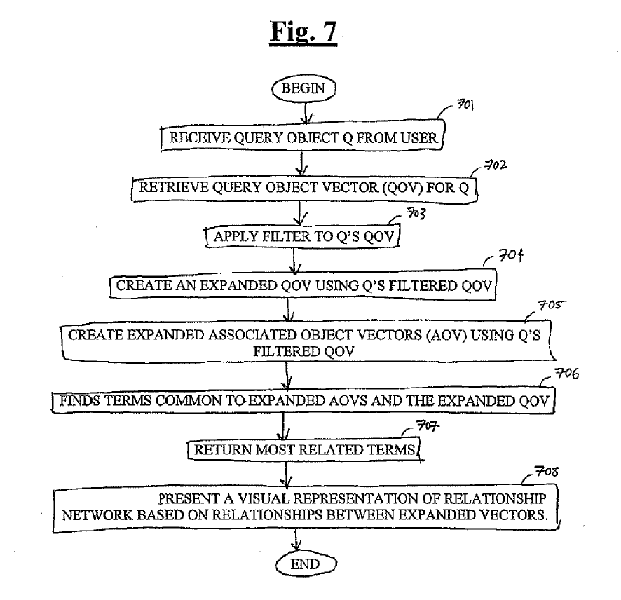

If a determination is made at the decision state 210 that the process 102 is at the last document, then the process moves to state 212 where it retrieves the recorded relationship data, such as from the associative memory module, for the first term in the database. Then the process moves to state 213 where a variable length query object vector is created using the relationship data from state 212. In certain embodiments, the relationship data values from state 212, which may be stored in a query object vector, may be enhanced when stored in the query object vector. Examples of enhancing the relationship data values include increasing the data values of unique associations and decreasing the data values for common associations. FIG. 6B shows the sample query object vector for the associative memory module of FIG. 6A. Next, the process moves to decision state 214 then checks to determine if the term analyzed is the last term in the database. If it is not the last term analyzed, the process moves to state 215 wherein the next term within the database is selected. The process 102 then returns to the state 213 wherein a query object vector for the next term is created. If a determination is made at the decision state 214 that the process 102 is at the last term, then the process terminates at the end state 216.

FIG. 3A shows a sample document 300 from an information database containing text documents. FIG. 3B shows the stored data from the document of FIG. 3A after it has been parsed 310. As it can be seen from the differences between FIGS. 3A and 3B, in this embodiment the system removed stop-words such as “they” 301 “from” 302 “until” 303 and “they're” 304 and also organized each sentence according to the identification of the document 311 it was found in and its terms 312.

As shown in FIG. 4, one embodiment of the context or frame 400 consists of associated terms surrounding and ultimately associated with the current, core term being analyzed in the frame, “red” 412. In one embodiment, the frame 400 and the space it encompasses are constructed by using distance thresholds within documents. For example, in FIG. 4, the distance threshold is one sentence before and one sentence after the sentence containing the core term being analyzed 410. If a term is within the distance threshold, it is considered an associated term and it becomes part of the context frame 400. On the other hand, if a term is outside the distance threshold, it will not become part of the context frame 400 and does not receive a distance score (also referred to as a score association) to the core term. Using the number of words in a document as well as number of sentences, paragraphs, characters or other objects, distance thresholds can be calculated and the size of the framed context 400 will grow and fluctuate as documents are read in and new statistical data is gathered. In one embodiment, wherein the digital content to be analyzed is raw text documents, the frame 400 is set to three, four or five sentences per frame. The example in FIG. 4 has a three sentence context frame 400.

The system may move the frame 400 through the documents or other parsed data which comprise the information database. As the frame is moved line by line through a set of documents, terms can be automatically associated with one another including an identifier representing the operative document 311. As terms flow in and out of the frame that moves through the documents, associated terms can define their strength of association to the core term by distance scores. For example, in FIG. 4, after the system has calculated the distance scores for the core term “red,” the focus of the frame will move to the next term, “pink,” until the focus reaches the final term in the middle line of the frame, “raspberry.” After the system has calculated the distance scores for terms associated with the term “raspberry”, the frame will advance by one line and the core term focus will begin with the first term on the next line, “Hummingbirds.” Furthermore, the sentence beginning with the term “bloom” will flow out of the frame and the sentence beginning with the term “one” will flow into the frame.

By giving a distance score to each associated term, each core term 410 in the document becomes a statistically important object containing a family of relationship scored associative terms as elements of its associative memory module. This provides one means for calculating a relationship score. The distance score between two terms may then be used to create a relationship score between two terms after the process completes analysis of the entire information database. For example, in one embodiment, distance scores between two terms as they appear repeatedly within a frame throughout the information database may be summed to create a relationship score.

Frame 400 usage in single documents becomes especially advantageous when relationship scores are generated over thousands or millions of documents. In certain embodiments herein, significant relationships between words are defined over time by strong and unique connections between two or more terms. Relationship scores to a term can be compared to the way a person might learn by repetition. A person will tend to remember and associate two terms together if he hears them together on a repeated basis, whereas a person may not remember or associate two terms together if he does not hear them together very often. In certain embodiments discussed herein, the system gives a high relationship score to two or more terms which appear often together. In certain other embodiments, two or more terms sharing a very unique set of attributes are scored highly.

As discussed above, the system may store relationships between a core term 410 and its associated term in file called an associative memory module that is created for the core term. In one embodiment, an associative memory module is a database schema storing information related to statistical and distance-based object associations, as well as document statistics. The associative memory module may thus advantageously capture meaning sensitivity in the data to be searched, which requires that the closeness of every pair of terms be known, scored for distance and stored. Thus, associative memory modules may advantageously store information such as words, paragraphs, search queries, objects, documents, document identifiers, parts of images, parts of terms, parts of text, parts of sequences or any piece of an object that has been split into parts, terms and documents, and many other types of information items similarly represented, such as numerical, financial, and scientific data. In one embodiment, every associated term in an associative memory module and vector is also the core term of its own associative memory module and vector, thereby enabling a high dimension many-to-many scored associative relationship network. In certain embodiments, this in turn enables strong comparison to occur between, for example, parts of terms, between terms, and terms and the documents they appear in.

In certain embodiments, the length of associative memory modules and vectors may be limited in order to facilitate faster creation of the relationship network or due memory storage constraints since the length of the vector or module may affect the size of the database and the system's performance capabilities. In other embodiments, an associative memory module or vector may contain as many elements as may be supported. In certain embodiments, the system may present a certain number of terms with a high score, or terms with a score above a certain threshold value in order to best represent the information database queried and to facilitate viewing by a user.

FIG. 5 shows a sample associative memory module for the term “red” 500 from FIG. 4 at a state where the current term being analyzed in the frame 400 is the core term “red” 410. The associative memory module 500 shown has three sections: statistics related to the term 510, statistics related to documents containing the term 520, and statistics related to associated terms 530. In the embodiment displayed, the first section, statistics related to the term 510, may contain information such as the number of occurrences of the term in the text analyzed 511, the number of sentences that contain the term 512, the number of other terms associated with the core term 513, and the number of associations between other terms with the core term 514. Since the associative memory module 500 displayed only contains data through analysis of the term “red” 410 in the first document analyzed in the database (FIG. 3A), the data in FIG. 5 reflects the incomplete analysis. Thus, since the term “red” 410 has occurred only once so far, and in only one sentence 412, the number of occurrences 510 and number of sentences 511 for the term “red” 410 both equal one. Similarly, since all eighteen of the terms analyzed so far are also all of the terms currently in the frame 400, they are all associated 513 with the term “red” 410. Furthermore, since none of these associated terms have yet appeared twice, they are all eighteen individual associations 514 for the term “red” 410.

The document statistics section 520 advantageously identifies documents 521 that contain the term, the number of sentences in the document that contain the term 522, and a score for the document in relation to the term 523. In the sample shown, only one document 524 is listed because it is the only document analyzed that contains the term “red”. The document 524 is identified by its title, although any other well known identification system may be used to record document identifications, such as a uniform resource locator (“URL”) address. Furthermore, only one sentence 525 that contains the term “red” has been found in the document. Consequently, a score 526 of one has been assigned to that document. In the embodiment shown, the score 526 associated with a document is the number of appearances of the term within the document, although in other embodiments other scoring methods may be used.

The associated terms section 530 includes, but is not limited to, data such associated terms 531, the number of occurrences of each associated term in relation to the core term 532 and the corresponding distance score for the associated term/core term pair 533. In other embodiments, the associated terms section 530 may also include data on the number of sentences processed so far that contain the associated term in relation to the core term and the distance of the associated term to the core term.

Distance scores 533 to measure associations between terms are applied within the moving frame. For example, FIG. 4 shows a three sentence frame 400 surrounding the core term, “red”. As the frame 400 and its core term focus 410 moves through the document a calculation is applied to assign distance scores to each term within the frame 400 in relation to the core term 410.

A distance score 533 may be calculated by any number of well known methods. Furthermore, in order to give greater value to associated terms in closer proximity to a core term, the distance score values 533 assigned to associated terms as their distance to the core term increases may advantageously be decayed. This may advantageously be applied using the Fibonacci sequence in reverse. In other words, in one embodiment using the Fibonacci sequence in reverse, the distance score from the core term to an associated term is:

Sᵢⱼ=φ^{Δx},

where:
Sᵢⱼ=distance score between core term i and associated term j,
φ=0.618 is the Golden Ratio component “phi”^{†}, and
Δx=|x₁−xⱼ| is the relative position between core term i and associated term j. ^{†}φ is the decimal component of the Golden Ratio φ=1.618034.

Returning to FIG. 5, the distance score 536 using this equation for the associated term “cardinal” to the term “red,” which are neighboring terms (Δx=1), is 0.618=0.618¹. Similarly, the distance score 537 for the associated term “bloom” to the term “red” is 0.008=0.618¹⁰, since “bloom” is ten terms away from “red” (Δx=10). In certain embodiments, as the system encounters a second occurrence between an associated term and a core term separate from the first occurrence, then the system may add the distance score of the second occurrence to the first occurrence in order to keep a running total of the distance score for the association. For example, in FIG. 5, if the system encounters the term “cardinal” 534 again within a frame containing “red”, and the distance score for the second occurrence is 0.008, then the system may update the distance score 536 for “cardinal” in the “red” associative memory module 500 to be 0.626=0.618+0.008. In other embodiments, other methods may be used to update a distance score value as the system processes an information database.

Calculations based on Fibonacci's number may be advantageously used because sequences based on the ratio of successive Fibonacci numbers, the Golden Ratio, are found in many natural phenomena, including biology and materials science. Fibonacci's number may thus have a relationship to grammar and human generated patterns and an effect on the interpretation of information.

In another embodiment, the Enhanced Exponentially Weighted Moving Average (EEMA), a variation of the EWMA (Exponentially Weighted Moving Average) time series calculation, may be used to compute distance scores between terms within a frame. A sample equation using the EEMA may be defined as:

EEMA=1/((K*(C−P)+P)

Where:
C=Position of the core term
P=Previous period's Simple Moving Average (SMA)
N=Number of periods for EEMA
K=e^{(-C/5.0)} Smoothing constant

In yet another embodiment, a standard exponential decay algorithm can be applied. Below are two equations for exponential decay that can be used to calculate distance scores:

If core term i comes before associated term j, then

Sij=1/e(j−i)

If core term i comes after associated term j, then

Sij=1/e(i−j)

where Sij=relationship score between object i and j,

FIG. 6A shows the associative memory module 600 for the term “red” after the system completes analysis of the information database containing the document of FIG. 3A. In the sample associative memory module 600, the system has determined that the information database analyzed contains twelve occurrences 611 of the term “red” in a total of twelve sentences 612. Furthermore, there are 319 terms associated with “red” and 450 associations between those terms and “red”. Whereas the document “Gardening Journal” 625 contained four sentences 626 totaling four occurrences of “red”, the document “Top News Stories” 628 only contained one sentence with one occurrence 630. Additionally, while the associated term “cardinal” 634 had six associations with red for whose individual distance scores summed to equal a total distance score 636 of 4.124, the associated term “paste” 637 only had one associated occurrence with “red” for a total distance score of 0.008.

After the system processes each document in the information database, each associative memory module may be used to create a query object vector. FIG. 6B shows a sample query object vector 650 created from the associative memory module 600 of FIG. 6A. In the embodiment shown, the distance score 633 from the associative memory module 650 is used to calculate the relationship score 653 for the query object vector 650 by emphasizing common associations, as will be discussed in further detail below. The system then ranks the associated terms in the query object vector 650 according to their relationship scores 653. For example, in FIG. 6B, the associated term “Cardinal” 654 is ranked first because it has the highest relationship score and the term “Paste” 655 is ranked at 319, which equals the total number of terms associated with “red,” because it has the lowest relationship score. Each associative memory module is thus used to create a query object vector 213.

FIG. 6B thus illustrates one advantage of the systems and methods described herein. In keyword based searches, if a user looking for red sweaters used the term “red” in her query, then she would only receive results where the sweaters were specifically listed with the term “red.” On the other hand, if the user submitted the search to an embodiment of the system described herein, the user would not only receive results for “red” sweaters, but for sweaters with other shades of red, such as cardinal, maroon and raspberry.

In certain embodiments, the system may advantageously use data from an associative memory module in order to create a different relationship score values for a query object vector. For example, in one embodiment, the distance score may be modified with the aim of emphasizing unique associations, such as to help in finding hidden relationships. Hidden relationships may be used to assist in hypothesis formulations by presenting a list of possibly important new relationships unknown to the user. In one embodiment, the following uniqueness function may be used to calculate a relationship score emphasizing uniqueness:

Uᵢⱼ=Sᵢⱼ·Bᵢⱼ

where:
Sᵢⱼ=Distance-based relationship score between term i and j
Bᵢⱼ=Bias for term i of association with term j,
   where:

Bᵢⱼ=Aᵢ/Aⱼ
Aᵢ=Total number of associations of term i
Aⱼ=Total number of associations of term j

In another embodiment, the distance score may be modified with the aim of emphasizing common associations such as to generate a clear definition based on direct associations. Direct associations can be used to generate a list of very similar objects. In one embodiment, the following commonality function may be used to calculate a relationship score emphasizing commonly associated terms:

Bᵢⱼ=Aⱼ/Aᵢ

where:
Aᵢ=Total number of associations of term i
Aⱼ=Total number of associations of term j

Thus, by the time the process of FIG. 2 completes, each term in each parsed document will have its own query object vector; i.e., each term will be a core term for a query object vector and an associated term for other term's query object vectors. In certain embodiments, each query object vector may either emphasize unique or common relationships. Furthermore, in certain embodiments, each document will also have its own associate memory module and query object vector. These vectors may then be used to build a relationship network.

2. Building A Relationship Network

FIG. 7 shows a process 700 for a network generation engine for use with embodiments of the relationship network discussed above. Specifically, disclosed is one embodiment for generating a relationship network using the query object vectors generated from an electronic information database containing text documents as described above. In response to a search query term inputted by a user, a relationship network may be generated from the extraction of relationships from query object vectors based upon the search query term. In certain embodiments, the relationship network would be comprised of a network of expanded vectors of terms, their connections to each other and the strength of these connections, where the connections are based on shared attributes within a defined frame. Although the sample flow chart illustrated discusses an embodiment using text documents and terms, in other embodiments, the query term may be audio data, video data, image data, or any other kind of electronic data.

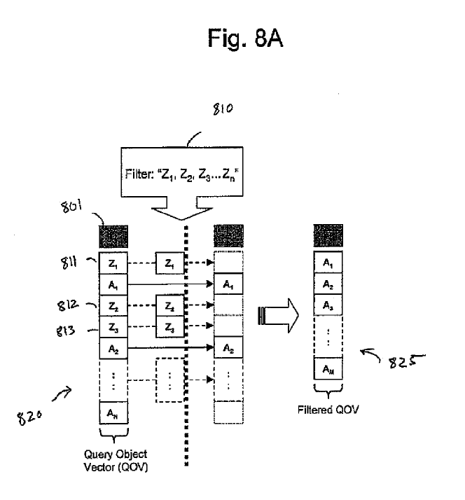

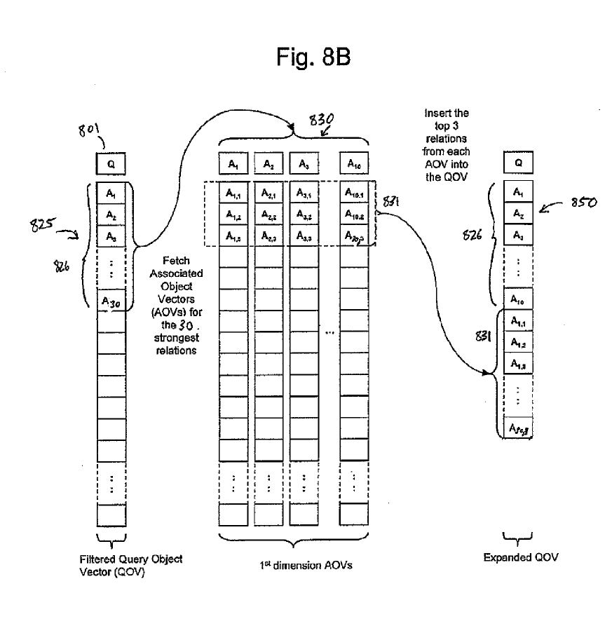

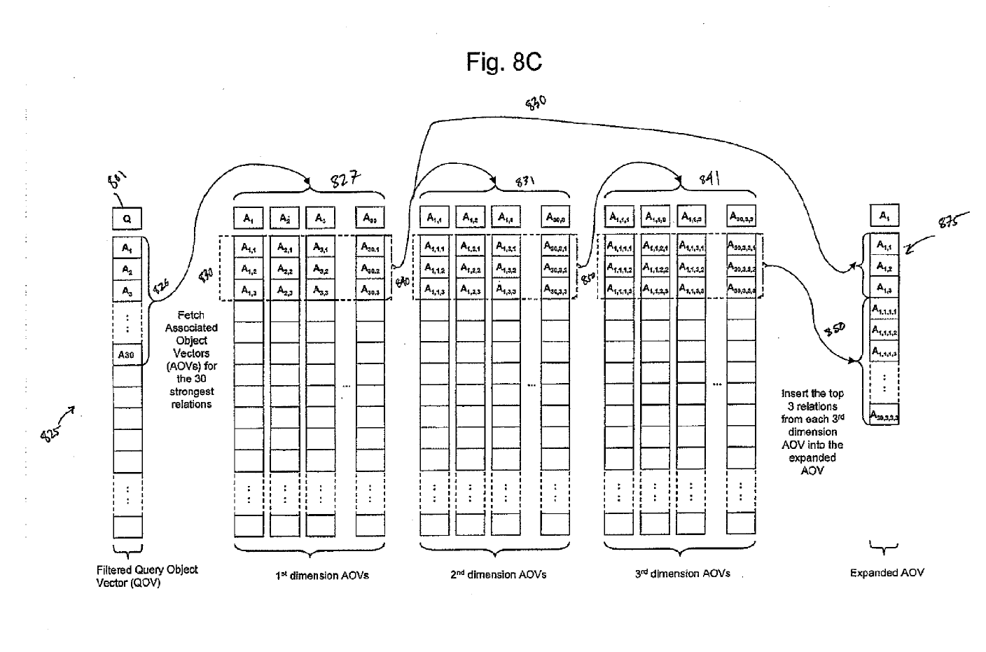

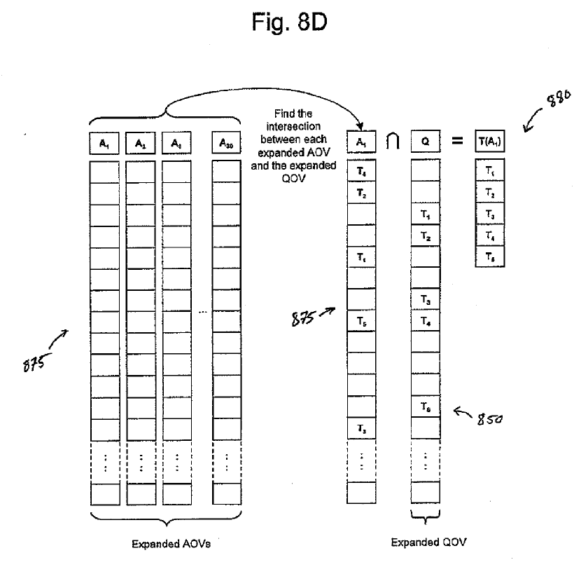

First, a user submits at least one query term, Q, to the system at a state 701. In certain embodiments, multiple terms may be submitted to the system, and may be treated as one query term or a multiple of query terms. In certain embodiments, if Q does not exist in the information database, then the system does not return any data. In response to receiving the query, the system retrieves the vector for the query term, the query object vector (“QOV”) at a state 702. The process 700 then moves to a state 703 wherein the user or system configures a filter for use with the query in order to focus the query results. This filter may be set, by for example, filtering terms out of the vector retrieved for the search term Q at the state 703. This will be discussed in further detail below with reference to FIG. 8A. Next, the system expands the vector into an expanded QOV at a state 704. This process will be discussed in further detail below with reference to FIG. 5B. The process 700 then moves to a state 705 wherein the system uses the QOV to generate expanded associated object vectors (“AOV”). This will be discussed in further detail below with reference to FIG. 8C. The system then moves to a state 706 to find associated terms between the expanded AOVs and the expanded QOV. Search results for the query Q are then provided at a state 707. The process of providing search results will be discussed below with reference to FIG. 8D. Finally, the process 700 presents a visual representation of the relationship network based on the query results.

In one embodiment, the system uses filters, such as forms of ontology of related themes and categories, to control the kind of relationships derived during the search process and to ensure that terms stay within a certain defined context when the relationship network is being built. In certain embodiments, filters may be employed because the terms selected for the filter also exist in the information database being searched, so the filter terms thus have vectors of their own. The filter may be supplied along with the query in order to focus the query results. The filter can be a list of words, symbols or objects by which the results of a query are controlled. For example, the filter phrase “genes and inferred relationships to drugs” may be used for a genomic search done on an information database related to genetic data.

In certain embodiments, the filter may be a complete vector wherein its elements represent the entire set of frame data or context in a database of documents to control the relationship extraction process. Any search results that are found to intersect with the vector-filter will be processed according to the type of filter used.

Many different kinds of filters may be enlisted for use with the systems and methods disclosed herein. One type of filter, an exclusion filter, can actively remove terms and vectors which do not match the filter. Exclusion filters may be used to assure that elements from a specific theme are removed from the query object vectors and associated object vectors for any aspect of the process. FIG. 8A shows a sample exclusion filter vector 810 containing the terms Z₁ to Zₙ. The filter vector is applied to the query object vector 820 retrieved for query Q 801 in order to focus the results of the query. As shown in FIG. 5A, the system advantageously removes instances of terms that appear in the filter vector. The terms Z₁, Z₂, and Z₃ have been filtered from the final query object vector 825 because those terms appear in the exclusion filter 810.

On the other hand, a selection filter can actively select terms and vectors which match the filter. Selection filters may be used to assure that only elements from a specific theme are used for a specific process. In one embodiment, the process includes the selection of top query term vector elements and associated term vector elements for generation of expanded query term vectors and associated term vectors. Filter elements also effect the selection of final terms being used in the expanded query term vector to expanded associated comparison and association score calculation.

Another type of filter, a weighting filter, may adjust the relationship scores of certain terms and vectors in order cause the terms or vectors to be reordered. Weighing filters may be used to alter the weight of a specific group of terms, thereby affecting their impact on the algorithm process and calculation results.

Filters may advantageously be applied during any point wherein the system is expanding the query object vector retrieved in response to a query. The use of filters results in the ability of the system to base relationships on specific sets of terms which may comprise a theme. Without theme filtering, the system might retrieve inferred relationships of all kinds which may not be beneficial if it is not known what kind of relationships to look for. For example, a user submitting the search query term “red” to an information database without a filter might receive very broad results. On the other hand, if the user employs a selection filter, which would exclude all terms not found in the filter, such as the filter phrase or vector “flowers” as a context for “red,” specific terms relating to red colored flora will most likely be found in the query results. In certain embodiments, filters may be predefined and interchangeable in order to allow a user to tailor a search query. Creating a network of term relationships with this kind of context control allows for previously unidentified connections to be brought to the fore as a user of the system might desire to find what relationships to this query term exist in a specified context.

FIG. 8B is a data flow diagram that shows one exemplary method of generating an expanded QOV 850 using the filtered QOV 825 of FIG. 5A. First, the system identifies the thirty strongest terms, A₁ to A₃₀ 826, related to the query term Q 801. These thirty strongest terms are added to the beginning 826 of the expanded QOV 850. Next, the system retrieves the vectors for each of those thirty terms, A₁ to A₃₀ 830, and inserts the top three strongest terms in each of those thirty vectors 831 (i.e., A_{1,1} to A_{1,3} for A₁, A_{2,1} to A_{2,3} for A₂, . . . . A_{10,1} to A_{10,3} for A₁₀) to complete the expanded QOV 850. Although the embodiment of the system shown selects thirty terms for processing, in other embodiments, any other number of terms may be used for processing.

FIG. 8C is a data flow diagram showing one method of generating an expanded AOV 875 using the filtered QOV 825 of FIG. 8A. First, the system identifies the thirty strongest terms, A₁ to A₃₀ 826, related to Q 801, retrieves their vectors 827, and begins an expanded AOV 875 for each term A₁ to A₃₀. Then the system identifies the three strongest terms from the first dimension vectors related to each of A₁ to A₃₀, (i.e., A_{1,1} to A_{1,3} for A₁, A_{2,1} to A_{2,3} for A₂, . . . A_{30,1} to A_{30,3} for A₃₀) 830, adds those associated terms to the corresponding expanded AOV 875, A₁ to A₃₀, and retrieves their vectors 831. Similarly, the system retrieves the three strongest terms from the second dimension vectors related to each A_{1,1} to A_{30,3}, (i.e., A_{1,1,1} to A_{1,1,3} for A_{1,1}, A_{1,2,1} to A_{1,2,3} for A_{1,2}, . . . A_{30,3,1} to A_{30,3,3} for A_{30,3}) 840 and retrieves their vectors 841. Once more, the system retrieves the three strongest terms from the third dimension related to each A_{1,1,1} to A_{30,3,3} (i.e., A_{1,1,1,1} to A_{1,1,1,3} for A_{1,1}, A_{1,1,2,1} to A_{1,1,2,3} for A_{1,2}, . . . A_{30,3,3,1} to A_{30,3,3,3} for A_{30,3,3}) 850. The top three associated terms from the third dimension vectors 850 are then inserted after the first dimension terms 830 already in the expanded AOV 875 to complete the expanded AOV 875. Although FIG. 8C shows the generation of an expanded AOV 875 for A₁, in the embodiment shown the process produces a total of 30 expanded AOVs for each A₁ to A₃₀ 826.

FIG. 8D is a data flow diagram that shows one exemplary method of using expanded AOVs 875 with an expanded QOV 850 to find associated terms between the AOVs 875 and the expanded QOV 850 in order to produce search results for the query Q 801. The expanded vectors 850 and 875 are passed to a function that determines similarity between intersecting terms in the expanded vectors 850 and 875. In one embodiment, as illustrated in FIG. 8D, the system may take the intersection of each expanded AOVs 875 and the QOV 850 in order to locate associated terms 880 for query term Q 801. In other embodiments, other functions may be used to locate associated terms.

In certain embodiments, a similarity score between the query term Q and each associated term may be calculated after associated terms for Q are located. The associated terms may then be ranked by their similarity score values, so that the associated term with the highest similarity score is ranked first. In certain embodiments, the similarity score function may be a correlation coefficient distance measurement and its value can be assigned to the resulting matching terms as a score signifying a final similarity measurement between the associated term and the initial query term, i.e., how much the results match the initial query term.

In one embodiment, the similarity score between two vectors may be calculated by taking the sum of the relationship scores from the intersecting terms and multiplying it by the length of the vector composed only of the intersecting terms. In another embodiment, the similarity score between two vectors may be a correlation coefficient distance measurement function which uses the following equations:

$$n ( {\sum }_{i = 1}^{N} {( V ⋂ W )}_{k} ) or ‖ X ‖ {\sum }_{i = 1}^{N} {X}_{k}$$

where

X=(V∩W)ₖ
V=query vector, and
W=any vector compared to the query vector.

In another embodiment, an uncentered Pearson correlation coefficient distance measurement may be used to calculate the similarity score between vectors of different sizes, wherein:

$${r}_{U} = \frac{1}{n} {\sum }_{i = 1}^{n} ( \frac{{x}_{i}}{{σ}_{x}^{( 0 )}} ) ( \frac{{y}_{i}}{{σ}_{y}^{( 0 )}} )$$

$$where$$

$${σ}_{x}^{( 0 )} = \sqrt{\frac{1}{n} {\sum }_{i = 1}^{n} {x}_{i}^{2}}$$

and wherein distance is defined by

d_{U}≡1−r_{U}

In certain embodiments, after the query result terms 880 are located, the vectors of each element returned for the query also extracted and compared and scored for similarity. This step advantageously allows for the results to be networked by intersecting the contents of their vectors. The network created by the intersection may be used to determine how the initial query results are related, in what context they relate, whether their connection is direct or indirect, and the strength of their relationships.

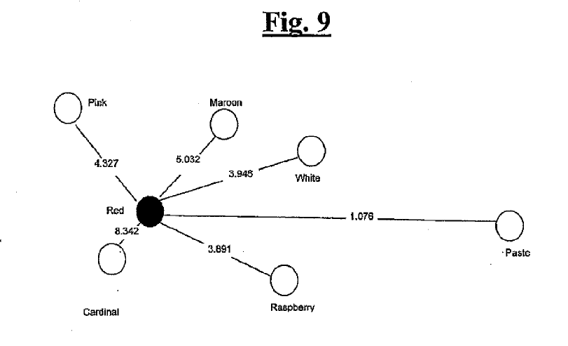

The query result data and the relationship network built using that data may thus advantageously show the relationship of the query term 801 to other terms, the relationship of vectors to one another, and the strength of their relationships using a similarity score. In certain embodiments, the resulting relationship network of the query result terms 880 and/or query-related vectors can be visualized if necessary for further interpretation. For example, FIG. 9 shows a graph visualization 900 (not drawn to scale) for a relationship network created in response to a query for the term “red.” Terms that have a higher relationship score to the term “red” appear closer to “red,” such as “cardinal” 654. Terms with a lower relationship score appear farther away, such as “paste” 655. A user may advantageously use a visualization similar to FIG. 9 in order to quickly understand the relationship between terms in the information database.

3. Example System Components

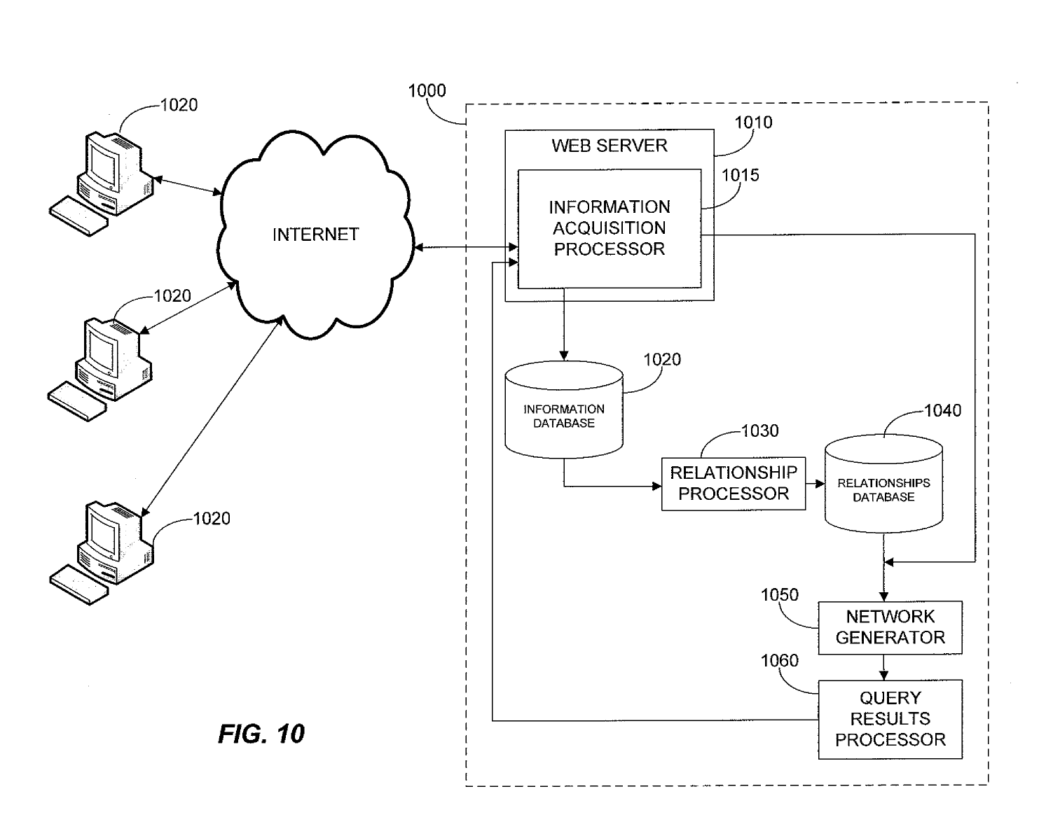

FIG. 10 illustrates a relationship network system 1000 according to one embodiment. The relationship network system 1000 includes a web server 1010 that generates and serves pages of a host web site to computing devices 1020 of end users. Although depicted as desktop computers 1020, the computing devices 1020 may include a variety of other types of devices, such as cellular telephones and Personal Digital Assistants (PDA). The web server 1010 may be implemented as a single physical server or a collection of physical servers. Certain embodiments may alternatively be embodied in another type of multi-user, interactive system, such as an interactive television system, an online services network, or a telephone-based system in which users select items to acquire via telephone keypad entries and/or voice.

The web server 1010 provides user access to electronic information represented within a database or a collection of databases 1020. An information acquisition processor 1015 that runs on, or in association with, the web server provides functionality for users to enter a search query for information they would like to find. In one embodiment, the information represented in the database 1020 may include documents, characters, words, images, songs, or videos or any other data that may be stored electronically. Many hundreds of thousands or millions of bytes of data may be stored in the database.

In one embodiment, a document or other object in the information database 1020 may be retrieved using the information acquisition processor 1015. Each object may be located by, for example, conducting a search for the item via the information acquisition processor 1015, or by selecting the object from a browse tree listing.

As illustrated in FIG. 10, the relationship network system 1000 includes a relationship processor 1030 which is responsible for, among other tasks, creating relationship vectors for the data in the information database 1020. These relationship vectors are then stored in the relationships database 1040. In certain embodiments, the relationship processor 1030 runs periodically and collectively analyzes or “mines” the information database in order to create and maintain the relationships database 1040 in response to new data that may be stored in the information database 1020.

In response to a query received by the information acquisition processor 1015, the relationship network system 1000 sends the query to the network generator 1050, which in addition to the query receives relationship vector information from the relationships database 1030 in order to generate a relationship network based on the query. In certain relationship network system embodiments, a set limit can be placed on the number of relationships that are created in order to address the substantially large amounts of relationships that can be created in web space, as discussed above.

The resulting relationship network is then sent to the query results processor 1060, which processes the results, optionally creates a visual representation of the relationship network, and sends this data to the information acquisition processor 1015. The results data may then be returned to computing devices 1020 that submitted the query via the Internet.

4. Example: Music Database

One embodiment of the invention may be implemented to discover relationships between human-generated content related to a database of music. Some examples of human-generated content relating to music are playlists, blogs, and recommendation lists. The system may determine relationships between music files based on their location within a directory or repository over a large data space, such as the Internet. This relationship data, which may include information such as the artist, album, title of the song and year of release, may be stored in associative memory modules, and then be transferred into query object vectors, as described above. Then, in response to a query, such as for an artist or a song, the system may create and present a relationship network of related artists or songs to the query and optionally visualize the relationship network.

5. Retrieving Summaries and Tags

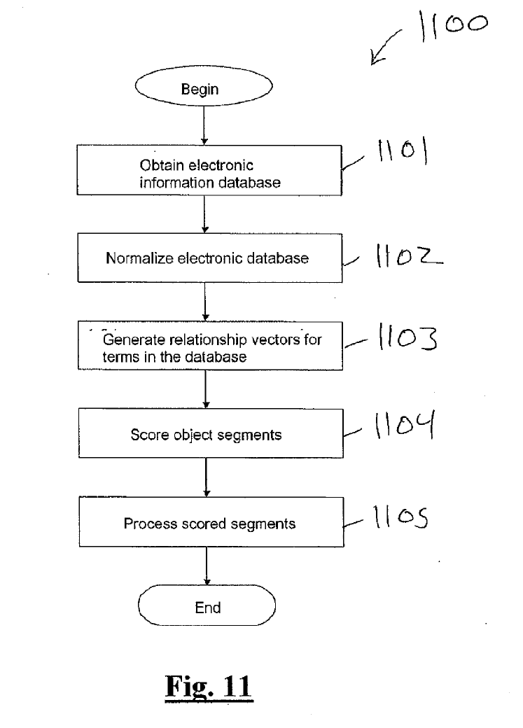

FIG. 11 is a flow chart showing a process 1100 for retrieving useful information from an electronic database. In certain embodiments, an electronic database may include, but is not limited to, a collection of characters or other forms of text, images, audio, video, or any other data that may be analyzed electronically. Objects or terms within the electronic database may thus be documents, paragraphs, sentences, characters, words, images, songs, or videos.

In the embodiment illustrated the system first selects an electronic database to process at state 1101. The database may be, for example, a database of musical compositions, the internet, the GENBANK gene database, or any other electronic information database

The system parses or normalizes the objects in the database at state 1102. In some embodiments, normalization includes extracting the plain text content, stopword removal, stemming, and filtering. Extracting the plain text may include removing HTML syntax or the like. The process of stopword removal involves removing commonly occurring words that are of low value (e.g. a, of, as, the, on, etc.) so that the information database contains only valuable terms. Stemming replaces a word that is in a plural or verb form with its root. Filtering may include removing words from an undesired words list. While these processes have been described with respect to textual information, the invention is not limited to text-based data. Similar concepts may be applied to other types of data, for example media data, to create a narrowed database that contains only useful information.

At state 1103 the system generates relationship vectors representing the electronic database as described above. The relationship vectors are accessed at state 1104 and used to score sections of the information database or of an object within the information database to determine the most relevant sections. The relationship vectors provide information as to the relative uniqueness of terms and the relationship between terms, which may serve as a basis for scoring. Sections of an object containing many terms that have a high relationship score or a high density of such terms will in turn be scored highly.

At state 1105 this scoring data is processed further to provide information to a user. For example, the scoring data may be used to create a summary of the object. In other embodiments, the scoring data may be used to generate recommended keywords or phrases for search engine queries. The scoring data may also be used to retrieve related media content.

### I. SCORING DOCUMENT SECTIONS

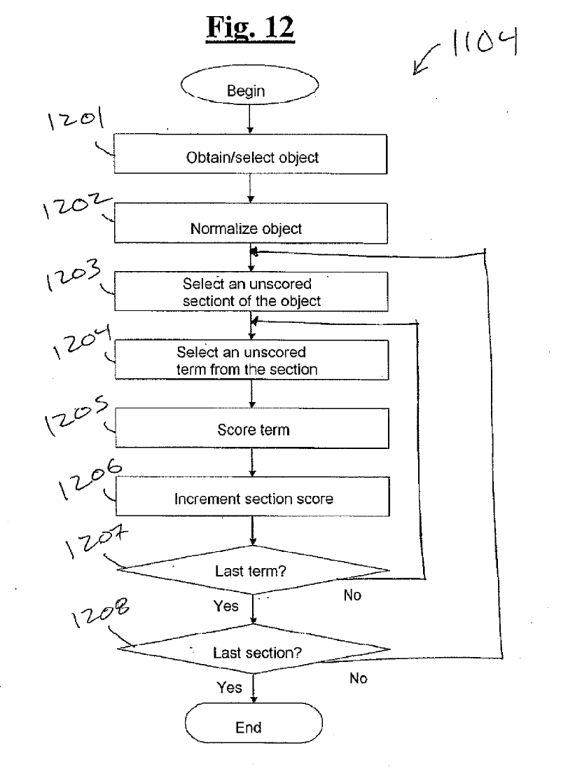

FIG. 12 is a flow chart for one embodiment of the scoring process 1104 of scoring document sections. This process may be carried out by a scoring module which includes instructions for performing the process 1104. The process 1104 includes state 1201, in which an object is obtained or selected. An object may be any document contained in the electronic database, or any combination of documents within the electronic database. An object may comprise the entire collection of an electronic database. In other embodiments, an object may be provided by a user that was not included in the electronic database when the relationship vectors were generated. In the examples described with reference to FIG. 12, the object contains text. However, in other embodiments the object may include images, audio, video, or any other type of data.

In state 1202 the object is normalized in a process similar to that utilized in normalizing the electronic database. When the electronic database or objects within the electronic database are being scored, this process may not need to be repeated. Instead, the previously normalized objects may be retrieved from a storage location. If normalization is performed, the steps may comprise extracting plain text content, stopword removal, stemming, filtering, and the like.

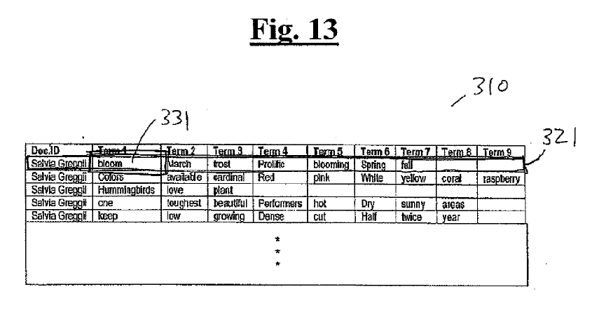

Next, at state 1203, a section that has not been scored is selected from the object. Sections may be sentences, paragraphs, phrases, entire documents, or some other portion of the object. Since none of the sections have yet been scored, the first section is selected. In one embodiment, FIG. 3A shows an object selected at state 1201. FIG. 3B shows a representation of that object after it has been parsed according to state 1202 of process 1104. In this example, sentences are used as sections and each sentence is shown on a separate line. FIG. 13 shows the first section selected according to state 1203, and the first term 331 of that section according to state 1204. In this example, that term 331 is “bloom.”

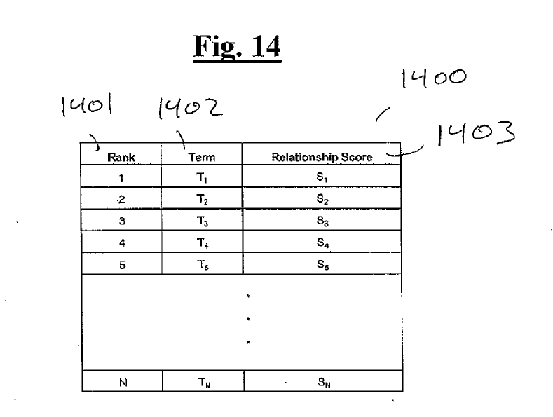

Next, process 1104 scores the selected term at state 1205. The term is scored utilizing the relationship vectors generated in process 1100 at state 1103. For example, the relationship vector may be a query object vector (QOV) having with a core term identical to the selected term, such as the sample QOV 1400 shown in FIG. 14. The QOV 1400 further includes a number of associated terms 1402 with rankings 1401 based upon relationship scores 1403. The relationship scores 1403 are used to calculate the term score. The relationship score for each of the associated terms is summed to provide the term score. The term score is used at state 1206 to increment the section score. Initially, the section score is zero, and thus the new section score after processing the first term will be equal to the term score.

Proceeding to decision block 1207, the system determines if the selected term is the last term in the selected section. If there are more terms, then the process 1104 returns to state 1204 and selects the next unscored term 322 from the currently selected section. In the sample shown in FIG. 3B, that term 322 would be “March.” Process 1104 then loops through states 1204, 1205, and 1206 until the last term 333 in the selected section is scored. In the example shown in FIG. 3B, that term 333 would be “fall.” For each term, a term score is calculated by summing the relationship scores of the previously generated QOV for that term. The section score is incremented with each term, so that the section score is the sum of all of the term scores for the terms in the selected section. When the last term is reached, process 1104 proceeds to decision block 1208.

At decision block 1208, the system determines if the selected section is the last section in the object. If the section is not the last, then the process 1104 returns to state 1203 and selects the next unscored section from the object. In FIG. 3B that section 322 is the second sentence which is represented on the second line. This newly selected section 322 proceeds through process 1104 in the same way as the previous section, calculating the section score by summing the term scores, which are generated from the relationship scores. When the new section is selected, it is associated with a new section score that is initially zero. After every term in the section has been scored and the section score is computed, the process 1104 returns to decision block 1208. If the selected section is the final section in the object being analyzed, then process 1104 ends and process 1100 proceeds to state 1105.

In other embodiments, sections may be scored using alternative methods. For example, information in an associated memory module may be used to form relationship scores for terms without forming QOVs for those terms. The section score may also be determined according to an algorithm other than summing the relationship scores of the terms in the section. For example, the term frequency of a particular term across an object may be compared with the term frequency across a segment and also with the number of terms shared by the object and the section, and the resulting score may be a function of these variables.

State 1105 of process 1100 handles the scored sections according to different embodiments of the invention to provide a user with relevant and focused information relating to the object being analyzed. In one embodiment, a summary module contains instructions that provide this information in the form of a summary of the object. This provides one means for providing a summary of the most relevant data items. In another embodiment, the summary module suggests query terms that may be used with a search engine or keyword search. In other embodiments, the information is media related to the object.

In one embodiment, at state 1105 the process 1100 may process the scored sections to create a summary of the object. The summary may contain highly relevant sections of the object, such as sentences, phrases, or paragraphs. Sections may also be data other than textual data. In other embodiments, the summary may take the form of any section or collection of sections.

To determine which sections are most relevant, the section scores are compared. In general, the sections with the highest scores will be the most relevant. In other embodiments, the section score may be further modified before ranking the sections. For example, the section score may be compared to the number of terms in the section.

The system then returns the most relevant sections to the user as a summary of the object. The sections may be returned in order of relevance, in the order they appear in the object, or based on some other factor. The system may also return a quantitative measure of the relevance of each section returned based on the section scores of those sections.

As an illustrative example, a database may contain a number of web pages returned in an internet search. Each web page may contain several pages of text, making it impractical to review the entirety of each document. Further, a keyword search may highlight sections that do not embody the nature of each web page or display web pages using the same term in a different context. A summary may therefore be desired for each result. For the first result, the summary generating system will score sections of that web page using the relationship vectors built from the electronic database consisting of the entire search results. The sections of the first web page result are scored as described above, and the top sections are returned as a summary. For example, the sections may be sentences and the top three scoring sentences may be returned. Repeating the process on each returned search result, a user would be able to quickly recognize the most relevant information from many pages of material by reference to a number of three sentence summaries. Alternatively, a summary may be provided for an entire collection that is treated as an object with, for example, sections set as paragraphs.

State 1105 of process 1100 may alternatively comprise returning one or more tags that may be recommended keywords or phrases for use in a search engine query. The sections are scored according to state 1104 of process 1100 or a similar process. Because of the different usage of these results, the sections and number of results may vary in form from other embodiments. In this embodiment sections are usually small, such as one to five terms. Additionally, more results may be returned depending on the application. For example, this process may return thirty sections as results in one embodiment. This is not meant to limit the invention, and the number of results returned as well as the size of the sections may easily be modified across any range for any application.

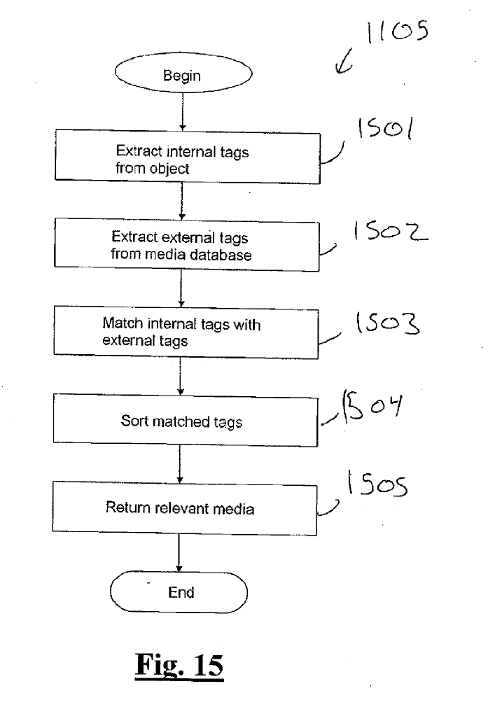

FIG. 15 shows process 1105 for retrieving media content related to an object according to one embodiment of the invention. Beginning at state 1501, internal tags are extracted from the object being analyzed. This step may be performed in a manner similar to that described with respect to returning suggested query terms. One or more highly ranked tags are thus associated with the object.

At state 1502 external tags are extracted from a media database. An example of a media database may be an internet video sharing website. External tags are extracted by analyzing data from videos, images, speech, audio, and other contextual data surrounding any form of media. At state 1503, those external tags are contextually matched to the internal tags. At state 1504 the matched tags are sorted or ranked. Those matches most relevant to an object may be returned at state 1505.

By way of example, an object may be a collection of internet search engine results. Internal tags may be extracted from the search engine results pages by creating relationship vectors associated with those pages and for each page retrieving one or more highly relevant contextual tags associated with that page. External tags are then extracted from data associated with video objects. The video objects may be accessed from, for example, a video sharing internet site. Relevant data used to construct the external tags may include images, video, descriptions of the video, and other information surrounding each video. The internal tags and the external tags are then matched, and the most relevant videos for each search engine results page may be returned.

In this example, relevant videos may be returned in a variety of ways such as by displaying thumbnails and links on a search engine results page. In other embodiments the videos may be playable on the search engine results page. The videos or links to the videos may also be e-mailed, shared, displayed on a blog, or the like. While video content has been used in these examples, other media may also be matched, returned, and displayed using similar methods.

### III. CONCLUSION

All of the features described above may be embodied in, and automated by, software modules executed by general purpose computers. The software modules may be stored in any type of computer storage device or medium. All combinations of the various embodiments and features described herein fall within the scope of the present invention.

Although the various inventive features and services have been described in terms of certain preferred embodiments, other embodiments that are apparent to those of ordinary skill in the art, including embodiments which do not provide all of the benefits and features set forth herein and do not address all of the problems set forth herein, are also within the scope of this invention. The scope of the present invention is defined only by reference to the appended claims.

What is claimed is:

1. An electronic system for summarizing information from an electronic search, comprising:
a memory for receiving a search term from a user;
a vector generator configured to generate a plurality of data vectors representing associations between said search term and a plurality of data items in an electronic database, wherein said data items comprise sections;
a scoring module configured to calculate a relationship score reflecting the relevance of said data vectors to said sections of said data items; and
a summary module configured to determine the most relevant sections of said data items.

2. The electronic system of claim 1, wherein said summary module is configured to calculate a summary of said sections for each of said data items and provide said summary to said user.

3. The electronic system of claim 1, wherein said electronic system is a personal computer.

4. The electronic system of claim 1, wherein said electronic search is an electronic search over the Internet.

5. The electronic system of claim 1, wherein said data items comprise web pages.

6. The electronic system of claim 5, wherein said sections comprises paragraphs of said web pages.

7. The electronic system of claim 1, wherein said data items comprise audio or video files.

8. The electronic system of claim 2, further comprising:
a search module configured to receive said summary and perform additional electronic searches based on terms in said summary.

9. An electronic system for summarizing information from an electronic search, comprising:
means for receiving a search string;
means for determining data items relating to said search term, wherein said data items comprise a plurality of sections and said sections comprise a plurality of terms;
means for calculating a relationship score reflecting the relevance of said search string to said sections of said data items; and
means for providing a summary of the most relevant data items by compiling terms from sections of said relevant data items.

10. The electronic system of claim 9, wherein said means for providing a summary is configured to calculate a summary of said sections for each of said data items and provide said summary to a user.

11. The electronic system of claim 9, wherein said electronic system is a personal computer.

12. The electronic system of claim 9, wherein said electronic search is an electronic search over the Internet.

13. A computer-implemented method for generating a summary of data items from an electronic search, comprising:
receiving a search string;
determining data items relating to said search term, wherein said data items comprise a plurality of sections and said sections comprise a plurality of terms;
calculating a relationship score reflecting the relevance of said search string to said sections of said data items; and
providing a summary of the most relevant data items by compiling terms from sections of said relevant data items.

14. The method of claim 13, wherein determining data items relating to said search term comprises selecting a first data item to be processed and selecting a first section within the first data item.

15. The method of claim 13, wherein calculating a relationship score comprises:
calculating a term score for each term in a first section based upon a relationship vector associated with each term; and
calculating a section score for said first section based upon each of the term scores.

16. The method of claim 13, wherein providing said summary comprises displaying a summary of said relevant data items to a user.

17. The method of claim 13, wherein providing said summary comprises providing said summary to a search module which provides additional searching based on said summary.

18. The method of claim 13, wherein said electronic search comprises an electronic Internet search.

19. The method of claim 13, wherein said data items comprise web pages.

20. The method of claim 13, wherein said data items comprises digital audio or digital video files.

21. The method of claim 13, wherein determining data items relating to said search term comprises calculating data vectors.

22. The method of claim 21, wherein calculating said data vectors comprises assigning a distance measurement to each of said data items based on its relationship to said search string.
